(19) United States
(12) Patent Application Publication
(10) Pub. No.: US 2007/0007190 A1
(43) Pub. Date: Jan. 11, 2007

(54) Filter ease

(76) Inventor: David L. Pethke, Manawa, WI (US)

Correspondence Address: Galasso & Associates, LP, P.O. Box 26503, Austin, TX, 78755-0503, US

(21) Appl. No.: 11/175,817

(22) Filed: Jul. 6, 2005

(51) Int. Cl. B01D 35/30

(52) U.S. Cl. 210/232

(57) ABSTRACT

The present invention is designed to offer an alternative to filters being installed and removed from various machines. The present invention provides for a wrench element placed opposite the base of the filter that would be either a male or female connection and would operate with standard tools. It would allow the user to be able to attach a standard tool to the wrench element that is integrally formed into the housing and use the wrench element to rotate the filter. By having the wrench element built into the housing it reduces the risk of slippage of the tool being used for installation and removal.

### TECHNICAL FIELD

This invention relates to various types of filters and the ability to insert and remove these filters from the machines in which they function. These filters include a variety of including air filters, water filters, oil filters and gas filters.

### BACKGROUND

The most common type of filter that we normally think of is an oil filter. However, most mechanical engines contain some type of filter. These filters operate to filter different elements, for example, gas filters, water filters, air filters and oil filters. As manufacturers continue to make engines small and more compact, the space for these various filters becomes smaller. The filters themselves do not always get small just the spacing for inserting and removing the filters. The smaller the space for the filter, the more likely the filter is to become heated and weld themselves to the connection component. Once the filters are welded to the connection component, they become very difficult to remove and sometimes require the filter to be taken off in pieces. Taking the filter off in pieces can be problematic because the filter will most likely contain some of the fluid in which it is filtering. If it is an air filter, this is not a big problem. However, if it is a liquid substance it will spill all over the engine. Unfortunately, you can not always clean up these spills. They tend to seep into areas where you cannot reach. Thereby, creating an environment whereby a fire could start and other problems can begin.

Probably the most common type of filter would be an oil filter for a vehicle. It is recommended that the oil filter and oil be changed every 3 months or 3,000 miles. This amounts to at least 4 oil changes a year. The biggest time consumption in changing the oil is changing the filter, whether it is done by the owner or a professional. If the oil filter is cold, it is harder to get off than if it is hot. However, if the filter is hot, there is an increased risk of getting seriously burned. There are some wrenches on the market that are designed to fit around the filter itself to assist in its removal. However, these wrenches are susceptible to slipping because the filter itself is oily. This leaves the individual changing the filter with scrapes and cuts on their knuckles.

### SUMMARY OF THE INVENTION

In one embodiment of the present invention would contain a housing for a filter wherein the top portion would be a screw type connection and the bottom portion would contain a wrench element.

In another embodiment, the filter element would operate to filter oil.

In another embodiment, the filter element would operate to filter water.

In another embodiment, the filter element would operate to filter gas.

In yet another embodiment, the filter element would operate to filter air.

In another embodiment, the housing element would be machined.

In another embodiment, the housing element would be made of stamped metal.

In another embodiment, the housing around the wrench element would be reinforced with a stiffner.

In yet another embodiment, the wrench element would be made of thermosetting plastic.

In another embodiment, the wrench element would be made of metal.

In another embodiment, the wrench element would be a female connection.

In still another embodiment, the wrench element would be a square female connection.

In yet another embodiment, the wrench element would be a male connection.

Still other advantages of various embodiments will become apparent to those skilled in this art from the following description wherein there is shown and described preferred embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

FIG. 1 is an elevational view of a filter which further depicts a wrench element opposite the base of the filter.

FIG. 2-2 is a cross-sectional side view of a filter wherein the elements of the filter are depicted.

FIG. 3 is a side view of depicting an alternate view of a wrench mechanism.

### BRIEF DESCRIPTION OF THE INVENTION

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

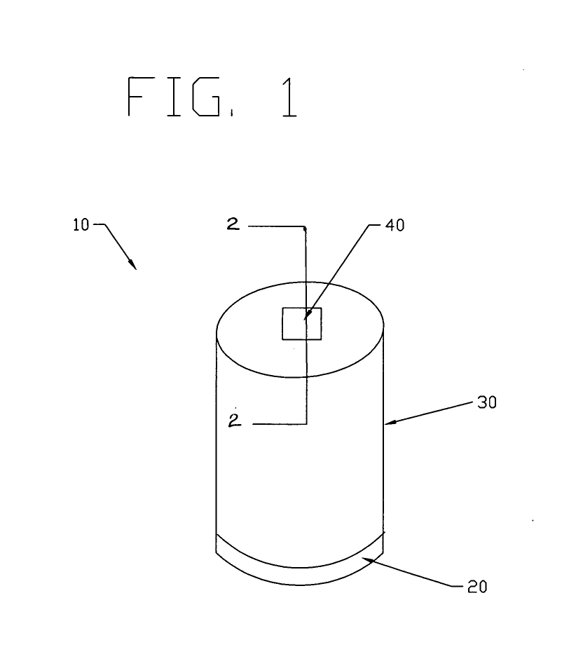

FIG. 1 depicts filter 10 operable to filter a substance as the substance moves through the filter. It includes a base 20, a housing 30 and a wrench element 40.

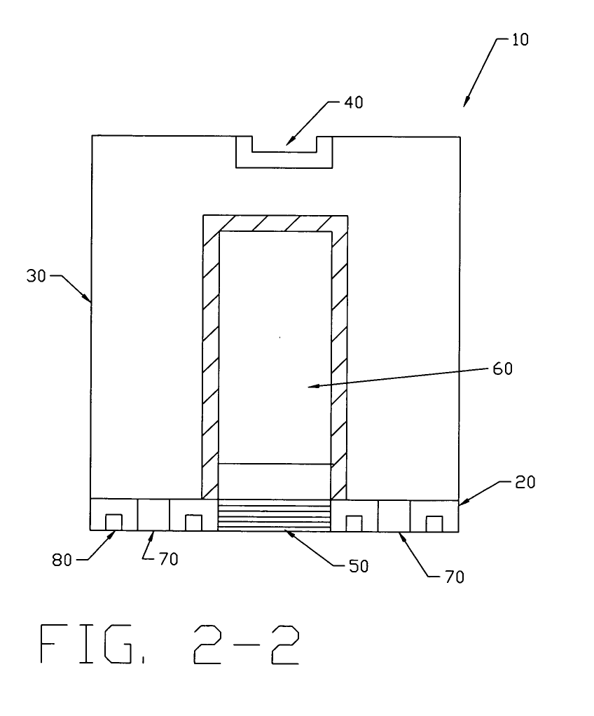

FIG. 2-2 is cross-sectional side view of a filter 10 depicting the elements of the filter 10. The filter 10 has a housing 30 which contains the filter element 90 that operates to filter the substance flowing through the inner port 60. This substance can be oil, water, gas, air or any other substance that needs to be filtered. The filter 10 also contains an attachment method which is depicted as a screw connector 50 which is depicted in FIG. 2-2. The screw connector 50 operates to allow the filter 10 to be screwably attached to a machine. The housing 30 can be made of from a stamped metal or machined. Once the filter 10 is attached to a machine the seal 80 operates to prevent any leakage of the substance to be filtered. The filter 10 also contains an inner port 60 and an outer port 70. The inner port 60 operates to allows the substance to be filter to flow into the filtering area and the outer port 70 provides a source for the substance to exit the filtering area once it has gone through the filter element 90. The inner port 60 and the outer port 70 operate in conjunction to provide a instrument that allows the continuous flow of the substance to being filtered. The wrench element 40 is designed to provide a means for installing and removing the filter 10 from any machine where it may be attached. This wrench element 10 may be an inset element which is integrally formed into the housing 30 as depicted in FIG. 2-2. This wrench element 40 allows the user of the filter 10 to be able to tighten or loosen the filter 10 is an easy manner. It also allows for the easy removal of the filter 10 in that the wrench element 40 is designed to fit most standard ratchets. Since the wrench element 40 is designed to work with most standard tools there is not a need for to buy special tools.

Due to the pressure being placed on the housing around the wrench element 40 during installation and removal, the housing 30 contains a stiffner operable to reinforce the housing particular around the wrench element 40. The wrench element 40 can be manufactured from a thermosetting plastic or metal. The wrench element 40 can be either a female connection or a male connection and would be totally up to the manufacturer. Regardless, of whether the wrench element 40 is a female or male connection the fact that it would be placed opposite of the base 20 and it would allow for the user to be able to operate the filter 10 with a standard wrench makes it an improvement. Additionally, because the wrench element 30 is either a female or male connection, the chances of the tool actually slipping is reduced.

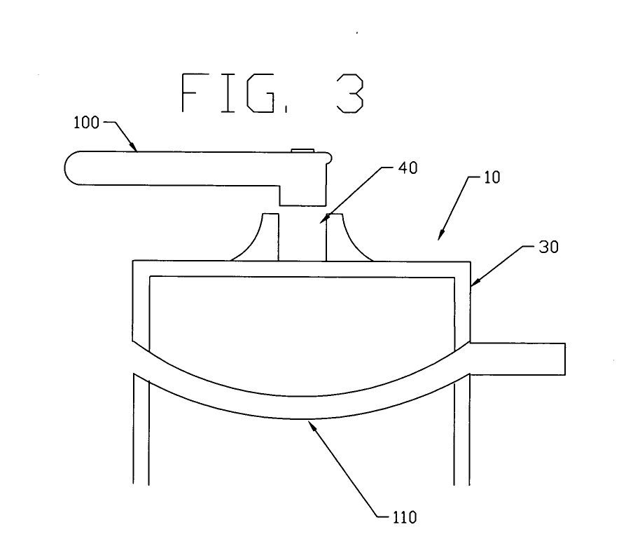

FIG. 3 depicts an alternative wrench element 40. In FIG. 3, the wrench element 40 is shown to be outwardly disposed from the filter 10. Again, the wrench element 40 could be a female or male connection even when outward disposed from the housing 30. Additionally, FIG. 3 shows the use of a single wrap around tool 110 which is capable of being used to screw and unscrew the filter. Alternatively, the use of a ratchet tool 100 is capable of attaching to the wrench element 40 for purposes of screwing and unscrewing the filter 10. The use of both a wrap around tool 110 and a ratchet tool 100 can be used in combination for purposes of screwing and screwing the filter 10 from the motor. By having the wrench element 40, you can either use the ratchet tool 100 separately, the wrap around tool 110 separately or the combination of the wrap around tool 110 with the ratchet tool 100. This allows the operate the option of an additional means of leverage which is sometimes required when trying to get some filters loose.

Although an embodiment of the present invention has been shown and described in detail herein, along with certain variants thereof, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention.

1. (canceled)

2. (canceled)

3. (canceled)

4. (canceled)

5. (canceled)

6. (canceled)

7. (canceled)

8. (canceled)

9. (canceled)

10. (canceled)

11. An oil filter for an automobile motor comprising:
a base having a screw type connect operable to be attached to an automobile motor;
a housing having a first and second end coupled to the base having an automobile motor oil filter element enclosed therein, said filter element including a filtering material;
a wrench element comprised of a thermosetting plastic integrally formed at said first end of the housing, the wrench element sized to be driven by a standard size ratchet driver;
a stiffener secured to the first end of the housing, the stiffener operable to reinforce the housing around the wrench element.

12. (canceled)

13. (canceled)

14. A filter of claim 11, wherein the wrench element consists of a female connection.

15. A filter of claim 11, wherein the wrench element is square shaped.

16. A filter of claim 11, wherein the wrench element consists of a male connection.

17. A filter of claim 11, wherein the wrench element is inset in the housing.

18. A filter of claim 11, wherein the Wrench element is outwardly disposed from the second end of said housing.

19. (canceled)

20. An oil filter for an automobile motor comprising:
a base having a screw type connect operable to be attached to the automobile motor;
a housing having a first and second end coupled to the base having an automobile motor oil filter element enclosed therein;
said filter element including a filtering material, and wherein said housing includes a first wrench element comprised of a thermosetting plastic integrally formed at said first end and a second wrap around tool, the first wrench element sized to be driven by a standard size ratchet driver;
a stiffener secured to the first end of the housing, the stiffener operable to reinforce the housing around the first wrench element; and
wherein said first wrench element is operable to couple with a first tool and said second wrap around tool is operable to couple around said housing such that at least one of said first wrench elements or said wrap around tool can be used to screw or unscrew said oil filter to/from the automobile motor.
